(19) United States
(12) Patent Application Publication
(10) Pub. No.: US 2025/0097619 A1
(43) Pub. Date: Mar. 20, 2025

(54) HEADPHONES COMPRISING A PLURALITY OF ACOUSTIC ELEMENTS

(71) Applicant: HEAVYS INC., New York, NY (US)

(72) Inventor: Axel GRELL, Burgdorf (DE)

(21) Appl. No.: 18/709,749

(22) PCT Filed: Nov. 13, 2022
(86) PCT No.: PCT/IB2022/060899

§ 371 Date: May 13, 2024

Related U.S. Application Data
(60) Provisional application No. 63/279,130, filed on Nov. 14, 2021.

(51) Int. Cl. H04R 1/10; H04R 1/40

(52) U.S. Cl. CPC H04R 1/1008; H04R 1/403

(57) ABSTRACT

A headphone device comprising two headphones and a set of two headphones are disclosed. The headphone comprising: a first set of directional sound transducers, and a second set of directional sound transducers. In some embodiments, the first set and the second set are positioned so that a direction of soundwaves generated by the first set is at predetermined angle of 80-120° to the direction of soundwaves generated by the second set.

### CROSS-REFERENCE TO RELATED APPLICATIONS

This application claims the benefit of priority of U.S. Provisional Patent Application No. 63/279,130, titled “HEADPHONES COMPRISING A PLURALITY OF ACOUSTIC ELEMENTS”, filed Nov. 14, 2021, the contents of which are incorporated herein by reference in their entirety.

### FIELD OF THE INVENTION

The present invention relates generally to headphones. More specifically, the present invention relates to headphones having a plurality of acoustic elements.

### BACKGROUND OF THE INVENTION

When listening to sounds generated from a distance, for example, during a face-to-face conversation, when listening to music at a concert, or music generated by loudspeakers, the soundwaves propagate substantially towards the front face of the listener. Therefore, these soundwaves will hit the listener's eardrum after interacting with various portions in the listener's ear. Each human has a unique ear structure; therefore, each human will have a unique hearing experience when listening to the same sounds.

Headphones are a pair of small loudspeaker drivers worn on or around the head over a user's ears. Headphones include electroacoustic transducers, which convert an electrical signal to a corresponding sound. In all commercial headphones, the transducers generate soundwaves which propagate directly toward the eardrum, almost without any interaction with other portions in the listener's ear. Therefore, when using the same type of headphones all listeners will hear substantially the same sounds.

Accordingly, there is a need for headphones that can provide the listener with a unique hearing experience provided when listening to sounds generated from a distance.

### SUMMARY OF THE INVENTION

Some aspects of the invention may be directed to a headphone comprising: a first set of directional sound transducers, and a second set of directional sound transducers. In some embodiments, the first set and the second set are positioned so that a direction of soundwaves generated by the first set is at predetermined angle of 80-120° to the direction of soundwaves generated by the second set.

In some embodiments, the first set comprises one or more low-frequency sound transducers and the second set comprises one or more high-frequency sound transducers. In some embodiments, the second set comprises at least two directional sound transducers. In some embodiments, the at least two directional sound transducers in the second set are positioned along a straight line forming a predetermined angle of 80-120° to the direction of soundwaves generated by the first set and to soundwaves generated by the second set.

In some embodiments, the second set of directional sound transducers is configured to generate sound waves having a sector of a cylindrical wavefront. In some embodiments, the second set of directional sound transducers is configured to generate sound waves in frequencies of at least 2000 Hz. In some embodiments, the headphone further comprises a holder for holding the first and second sets of directional sound transducers. In some embodiments, the holder is included in a housing comprising a main baffle and a peripheral baffle and wherein the second set of directional sound transducers is arranged in an angle of 80° to 120° with respect to the main baffle. In some embodiments, the second set of directional sound transducers is attached to the peripheral baffle. In some embodiments, the first set of directional sound transducers is attached to the main baffle.

In some embodiments, the first set of directional sound transducers comprises low-frequency sound transducers configured to generate sounds in a frequency range below 2000 Hz. In some embodiments, the holder is configured to hold the second set of directional sound transducers at a distance of at most 5 mm from a user's skin in proximity to the user's ear tragus when the headphone is positioned on a user's head. In some embodiments, the headphone further comprises a ped covering an outer surface of the peripheral baffle. In some embodiments, the holder is selected from an arc configured to be placed over the head and a clip configured to mount the headphone over an ear.

Some additional aspects of the invention may be directed to a headphone device comprising two headphones according to any one of the embodiments disclosed herein above, connected by a holder. Some additional aspects of the invention may be directed to a headphone kit comprising two headphones according to any one of the embodiments disclosed herein above, comprising two clip holders, a first clip holder is configured to mount a right headphone to a right ear and a second clip holder is configured to mount a left headphone to a left ear.

Some additional aspects of the invention may be directed to a headphone comprising: a holder; and a sound source attached to the holder, configured to generate sound waves having a sector of a cylindrical wavefront at 5-60 mm from the sound source.

In some embodiments, the sound source comprises two or more circular sound transducers, and wherein the two or more point transducers are distanced from each other such that a superposition of wavefronts of sound waves generated by the two or more transducers, creates the sector of the cylindrical wavefront.

In some embodiments of the invention may be directed the sound source includes at least one of, a rectangular transducer and an oval transducer. In some embodiments of the invention may be directed the sound source is configured to generate sound waves in frequencies of at least 2000 Hz.

In some embodiments, the holder is included in a housing comprising a main baffle and a peripheral baffle and wherein the sound source is arranged in an angle of 60° to 100° with respect to the main baffle. In some embodiments, the sound source is attached to the peripheral baffle. In some embodiments, the headphone further comprises one or more low-frequency sound transducers configured to generate sounds in a frequency range below 2000 Hz. In some embodiments, one or more low-frequency sound transducers are attached to a main baffle.

In some embodiments, the holder is configured to hold the sound source at the distance of at most 5 mm from a user's skin in proximity to the user's ear tragus when the headphone is positioned on a user's head. In some embodiments, the headphones further comprise a ped covering an outer surface of the peripheral baffle. In some embodiments, the holder is selected from an arc configured to be placed over the head and a clip configured to mount the headphone over an ear.

Some additional aspects of the invention may be directed to headphone comprising: a holder configured to be placed at a vicinity of a human ear; and one or more sound transducers attached to the holder, such that when positioned on the human ear, the one or more sound transducers are located near the ear's tragus, such that sound waves generated by the one or more sound transducers propagate towards the back of the head.

In some embodiments, the headphone may further include two or more sound transducers that are distanced from each other such that a superposition of wavefronts of the propagating sound waves, creates a cylindrical wavefront. In some embodiments, one or more sound transducers are configured to generate sound waves in frequencies of at least 2000 Hz. In some embodiments, the holder is included in a housing comprising a main baffle and a peripheral baffle and wherein the sound source is arranged in an angle of 80° to 120° with respect to the main baffle. In some embodiments, the sound transducers are attached to the peripheral baffle.

In some embodiments, comprising one or more low frequency sound transducers configured to generate sounds in a frequency range below 2000 Hz. In some embodiments, the one or more low frequency sound transducers are attached to a main baffle. In some embodiments, the headphone further comprises a ped covering an outer surface of the peripheral baffle. In some embodiments, the holder is selected from an arc configured to be placed over the head and a clip configured to mount the headphone over an ear.

Some additional aspects of the invention may be directed to a headphone device comprising two headphones according to any one of the embodiments disclosed, wherein the holder is an arc configured to hold a first headphone at a first end of the holder and a second headphone at a second end of the holder, such that the wavefronts of sound waves generated by both cylindrical sound sources are propagating at the same direction. Some additional aspects of the invention may be directed to a headphone kit comprising two headphones according to any of the embodiments disclosed herein above, comprising two clip holders, a first clip holder is configured to mount a right headphone to a right ear and a second clip holder is configured to mount a left headphone to a left ear, such that the wavefronts of sound waves generated by both cylindrical sound sources are propagating at the same direction.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is an illustration of a headphone attached to a head of a user according to some embodiments of the invention;

FIG. 1B is an illustration of a headphone according to some embodiments of the invention;

FIGS. 2A and 2B are illustrations of headphone devices according to some embodiments of the invention;

FIG. 2C is an illustration of a headphone kit according to some embodiments of the invention; and

FIGS. 3A and 3B are three-dimensional views and an exploded view of a nonlimiting design of a headphone according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Some aspects of the invention are directed to headphones that can provide the listener with a sense of hearing sounds from a distance, for example, when sitting in a concert hall or listening to music via loudspeaker. Such headphone may allow providing the specific frequency response on the eardrum, for each user. The headphone may be equipped with a high-frequency sound source (e.g., having one or more sound transducers) configured to generate sound waves having a sector of a cylindrical wavefront. This sound source may generate sound waves having frequencies above 2000 Hz and may be positioned, using a holder, near the ear's tragus, such that the sound waves generated by the one or more sound transducers propagate towards the back of the head.

In some embodiments, the headphones may further include an additional low frequency sound source configured to generate soundwaves below 2000 Hz. The low frequency soundwaves may propagate at predetermined angle of 80-120° to the propagation direction of soundwaves generated by the high-frequency sound source.

In some embodiments, the high-frequency soundwaves (i.e., above 2000 Hz) may be generated by a relatively thin cylindrical sound source that runs along the surface of the head until it reaches the outer ear where it creates typical individual resonances and reflections as a sound wave coming from the front in a natural sound field. In some embodiments, the low-frequency sound source (i.e., below 2000 Hz) may be generated by transducers placed above the concha. As would be understood by one skilled in the art, the impact of the individual geometry of the outer ear in frequencies below 2000 Hz is negligible. The low-frequency transducers need to have a relatively large surface to avoid audible distortion (in comparison to the high-frequency transducers).

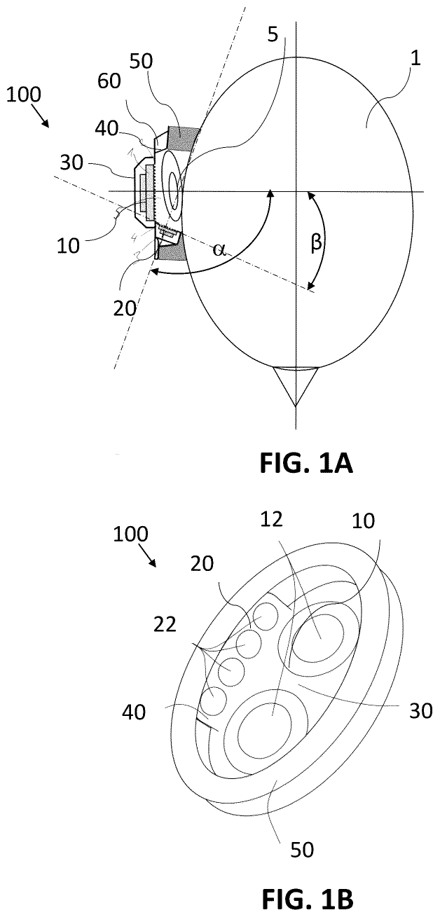

Reference is now made to FIG. 1A which is an illustration of a headphone attached to the head of a user according to some embodiments of the invention; and to FIG. 1B which is an illustration of a headphone according to some embodiments of the invention.

A headphone 100 may include a first set of directional sound transducers 10 and a second set of directional sound transducers 20. In some embodiments set 10, also referred herein as first sound source, may include one or more sound transducers 12 and set 20, also referred to herein as, second sound source, may include one or more sound transducers 22. In some embodiments, first set 10 and the second set 20 are positioned so that a direction of soundwaves generated by first set 10 is at a predetermined angle α of 80-120° (e.g., 110°) to the direction of soundwaves generated by second set 20.

In some embodiments, first set 10 may include one or low-frequency sound transducers 12 (e.g., configured to generate soundwaves at frequencies below 2000 Hz) and second set 20 may include one or high-frequency sound transducers (e.g., configured to generate soundwaves at frequencies above 2000 Hz). In a nonlimiting example, low-frequency sound transducers 12 may have a diameter of 20-50 mm.

In some embodiments, the second set 20 includes at least two directional sound transducers 22. In some embodiments, at least two directional sound transducers 22 are positioned along a straight line forming a predetermined angle β of 60-100° to the direction of soundwaves generated by the first set and to sound waves generated by the second set.

In some embodiments, the second set 20 of directional sound transducers is configured to generate sound waves having a sector of a cylindrical wavefront. In some embodiments, two or more sound transducers 22 in set 20 may be distanced from each other such that a superposition of wavefronts of the propagating sound waves, creates the sector of a cylindrical wavefront. In a nonlimiting example, sound transducers 22 may be round transducers having a dimeter of 6-12 mm distanced at 6 mm from each other.

In some embodiments, headphone 100 may further include a holder 60. Holder 60 may be configured to hold first set 10 and second set 20.

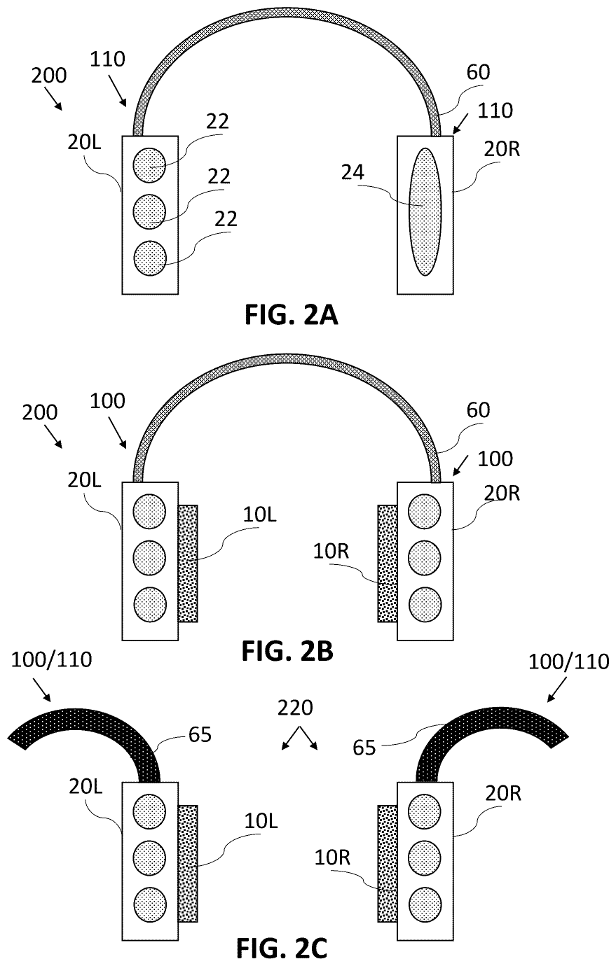

In some embodiments, headphone 100 may include holder 60 and at least second set 20, as illustrated in FIG. 2A. In some embodiments, holder 60 may be configured to be placed at a vicinity of a human ear 5; and one or more sound transducers 22 are attached to holder 60, such that when positioned on human ear 5, one or more sound transducers 22 are located near the ear's tragus, such that sound waves generated by one or more sound transducers 22 propagate towards the back of head 1. In some embodiments, holder 60 is configured to hold second set 20 of directional sound transducers 22 at the distance of at most 5 mm from a user's skin in proximity to user's ear 5 tragus when the headphone is positioned on a user's head 1.

In some embodiments, holder 60 may be included in a housing comprising a main baffle 30 and a peripheral baffle 40 and second set of directional sound transducers 20 is arranged in an angle of 80° to 120° (e.g., 100-120°, 100°, etc.) with respect to main baffle 30. In some embodiments, the second set 20 of directional sound transducers 22 is attached to peripheral baffle 40. Peripheral baffle 40 may have an oval shape (as illustrated) that includes oval walls surrounding main baffle 30. In some embodiments, peripheral baffle 40 may have any other suitable shape. Maine baffle 30 may be a plate, which can be either flat or non-flat, located in between the walls of peripheral baffle 40. In some embodiments, the first set 10 of directional sound transducers 12 is attached to main baffle 30, as illustrated. In a nonlimiting example, directional sound transducers 12 may be located at 20-30 mm in front of a vertical plane that intersects with ear 5 in its geometric center.

In some embodiments, headphone 100 may further include a ped 50 covering an outer surface of the peripheral baffle, for providing cushioning and more comfortable attachment of headphone 100 to head 1.

In some embodiments, two headphones 100 connected by holder 60 may be included in a headphone device and the holder may be or may include an arc configured to be placed over the head, (as illustrated in FIGS. 2A and 2B), around the back of the neck, around the lower portion of the back of the head and the like. In some embodiments, a single headphone 100 may include a clip holder (e.g., clip holder 65 illustrated in FIG. 2C). In some embodiments, the clip may be configured to mount headphone 100 over ear 5. In some embodiments, two headphones 100 each comprising a clip holder may be included in a headphone kit. In some embodiments, a first clip holder is configured to mount a right headphone to a right ear and a second clip holder is configured to mount a left headphone to a left ear, for example, as illustrated and discussed with respect to FIG. 2C.

Reference is now made to FIGS. 2A and 2B which are illustrations of headphone devices 200 according to some embodiments of the invention. Headphone device 200 may include one or more headphones 110, illustrated in FIG. 2A or one or more headphones 100 illustrated in FIG. 2B. The two headphones 100 or the two headphones 110 may be connected by holder 60 such as an arc configured to be placed over the head, as illustrated, around the back of the neck, around the lower portion of the back of the head and the like.

In some embodiments, one or more headphones 100 of FIG. 2B may be or may include substantially the same elements as headphone 100 illustrated in FIGS. 1A and 1B and discussed herein above.

In some embodiments, headphone device 200 may include one or two headphones 110 which includes holder 60. Headphone 110 may include a sound source 20L and/or 20R (e.g., a set of one or more sound transducers 22 or 24) attached to holder 60 and configured to generate sound waves having a sector of a cylindrical wavefront at 5-60 mm from sound source 20L or 20R. In some embodiments, sound source 20L may be configured to be positioned on a human left ear, near the left ear's tragus, such that sound waves generated by the one or more sound transducers 22 propagate towards the left side of the back of the head. In some embodiments, sound source 20R may be configured to be positioned on a human right ear, near the right ear's tragus, such that sound waves generated by the one or more sound transducers 24 (or 22, as illustrated in FIG. 2B) propagate towards the right side of the back of the head.

In some embodiments, holder 60 may be configured to hold sound source 20L at a distance of at most 5 mm from a user's skin in proximity to the user's left ear tragus when the headphone is positioned on a user's head and/or to hold sound source 20R at a distance of at most 5 mm from a user's skin in proximity to the user's right ear tragus when the headphone is positioned on a user's head.

In some embodiments, sound source 20L may include two or more circular sound transducers 22, as discussed herein above. In some embodiments, two or more circular transducers 22 are distanced from each other such that a superposition of wavefronts of sound waves generated by two or more transducers 22, creates the sector of the cylindrical wavefront. In some embodiments, sound source 20R includes at least one of, a rectangular transducer and an oval transducer, for example, oval transducer 24 illustrated. In some embodiments, sound source 20 is configured to generate sound waves in frequencies of at least 2000 Hz.

In some embodiments, holder 60 is included in a housing comprising a main baffle and a peripheral baffle and the sound source is arranged in an angle of 60° to 100° with respect to the main baffle, as illustrated and discussed above with respect to FIGS. 1A and 1B. Accordingly, sound source 20R or 20L may be attached to the peripheral baffle.

Reference is now made to FIG. 2B with is an illustration of headphone devices 200 that includes one or more headphone 100. Headphone 100 may include substantially the same elements of headphone 110 and may further include one or more low frequency sound transducers, for example, sound transducers 12 included in set 10 which configured to generate sounds in a frequency range below 2000 Hz. In some embodiments, the one or more low frequency sound transducers are attached to a main baffle, for example, main baffle 30.

Reference is now made to FIG. 2C which is an illustration of a headphone kit 220 comprising two headphones 100 or 110. The two headphones 100 or 110 may include two clip holders 65, a first clip holder is configured to mount a right headphone to a right ear and a second clip holder is configured to mount a left headphone to a left ear, such that the wavefronts of sound waves generated by both sound sources 20R and 20L are propagating in the same direction.

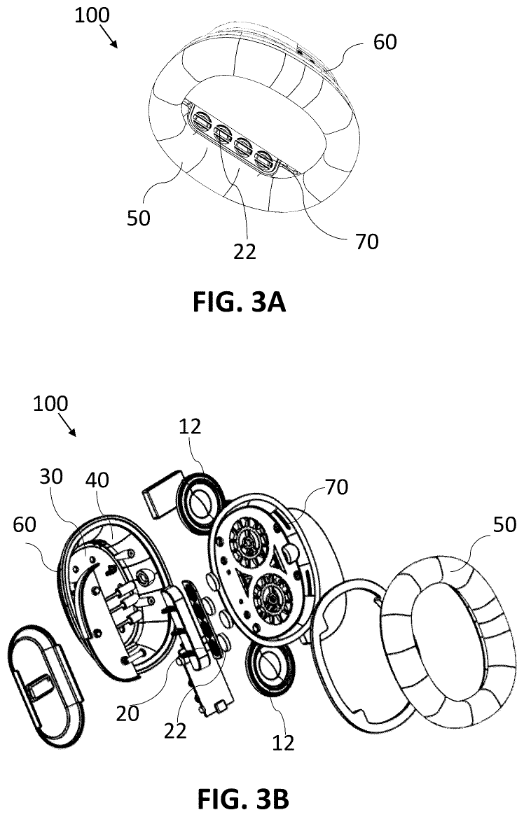

Reference is now made to FIGS. 3A and 3B which are a three-dimensional view and an exploded view of a nonlimiting design of a headphone according to some embodiments of the invention. FIGS. 3A and 3B show a nonlimiting design of headphone 100 and includes substantially the same elements as discussed above with respect to FIGS. 1A and 1B. In some embodiments, headphone 100 may further include a cover 70 for protecting and covering transducers 12 and 22. Cover 70 may include various slots allowing the soundwaves from transducers 12 and 22 to propagate towards ear 5.

As should understood by one skilled in the art, the design of headphone 100 illustrated in FIGS. 3A and 3B is given as an example only and the invention is not limited to this specific design.

Accordingly, headphones according to embodiments of the invention may provide to the user a more “natural” listening experience, mimicking the specific frequency response on the eardrum the user has when hearing sounds (e.g., music) from a distance.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A headphone comprising:
a first set of directional sound transducers, and
a second set of directional sound transducers,
wherein the first set and the second set are positioned so that a direction of soundwaves generated by the first set is at predetermined angle of 80-120° to the direction of soundwaves generated by the second set.

2. The headphone according to claim 1, wherein the first set comprises one or more low frequency sound transducers and the second set comprises one or more high frequency sound transducers.

3. The headphone according to claim 1 wherein the second set comprises at least two directional sound transducers.

4. The headphone according to claim 3 wherein the at least two directional sound transducers in the second set are positioned along a straight line forming a predetermined angle of 80-120° to the direction of soundwaves generated by the first set and to soundwaves generated by the second set.

5. The headphone according to claim 1, wherein the second set of directional sound transducers is configured to generate sound waves having a sector of a cylindrical wavefront.

6. The headphone according to claim 1, wherein the second set of directional sound transducers is configured to generate sound waves in frequencies of at least 2000 Hz.

7. The headphone according to claim 1, further comprising a holder for holding the first and second sets of directional sound transducers.

8. The headphone according to claim 7, wherein the holder is included in a housing comprising a main baffle and a peripheral baffle and wherein the second set of directional sound transducers is arranged in an angle of 80° to 120° with respect to the main baffle.

9. The headphone of claim 8, wherein the second set of directional sound transducers is attached to the peripheral baffle.

10. The headphone of claim 8, wherein the first set of directional sound transducers is attached to the main baffle.

11. The headphone of claim 1, wherein the first set of directional sound transducers comprises low frequency sound transducers configured to generate sounds in a frequency range below 2000 Hz.

12. The headphone of claim 7, wherein the holder is configured to hold the second set of directional sound transducers at the distance of at most 5 mm from a user's skin in proximity to the user's ear tragus when the headphone is positioned on a user's head.

13. The headphone of claim 8, further comprising a ped covering an outer surface of the peripheral baffle.

14. The headphone of claim 1, wherein the holder is selected from an arc configured to be placed over the head and a clip configured to mount the headphone over an ear.

15. A headphone device comprising two headphones according to claim 1 connected by a holder.

16. A headphone kit comprising:
two headphones according to claim 1; two clip holders, a first clip holder is configured to mount a right headphone to a right ear and a second clip holder is configured to mount a left headphone to a left ear.

17. A headphone comprising:
a holder; and
a sound source attached to the holder, configured to generate sound waves having a sector of a cylindrical wavefront at 5-60 mm from the sound source.

18. The headphone of claim 17, wherein the sound source comprises two or more circular sound transducers,
and wherein the two or more point transducers are distanced from each other such that a superposition of wavefronts of sound waves generated by the two or more transducers, creates the sector of the cylindrical wavefront.

19.-29. (canceled)

30. A headphone comprising:
a holder configured to be placed at a vicinity of a human ear; and
one or more sound transducers attached to the holder, such that when positioned on the human ear, the one or more sound transducers are located near the ear's tragus, such that sound waves generated by the one or more sound transducers propagate towards the back of the head.

31. The headphone of claim 30,
comprising two or more sound transducers that are distanced from each other such that a superposition of wavefronts of the propagating sound waves, creates a cylindrical wavefront.

32.-40. (canceled)
